(19) United States
(12) Patent Application Publication
(10) Pub. No.: US 2003/0158683 A1
(43) Pub. Date: Aug. 21, 2003

(54) Temperature calibration using on-chip electrical fuses

(76) Inventors: Claude Gauthier, Fremont, CA (US); Spencer Gold, Pepperell, MA (US); Dean Liu, Sunnyvale, CA (US); Kamran Zarrineh, Billerica, MA (US); Brian Amick, Austin, TX (US); Pradeep Trivedi, Sunnyvale, CA (US)

Correspondence Address: ROSENTHAL & OSHA L.L.P. / SUN, 1221 MCKINNEY, SUITE 2800, HOUSTON, TX, 77010, US

(21) Appl. No.: 10/078,760

(22) Filed: Feb. 19, 2002

(51) Int. Cl. G06F 19/00

(52) U.S. Cl. 702/99

(57) ABSTRACT

An integrated circuit that uses electrical fuses to store calibration information of a thermal monitoring device residing on the integrated circuit is provided. Such an integrated circuit allows a service processor of a computer system to query the integrated circuit for calibration information so that an accurate actual temperature measurement may be determined. Further, a method for reading and storing temperature calibration information on-chip is provided.

### BACKGROUND OF INVENTION

As shown in FIG. 1, monolithic integrated circuits (10) are fabricated several at a time on single chips (or “wafers”) (12) of silicon or dice (the singular being “die”). This means that the passive and active structures of the integrated circuits (10) are manufactured all at the same time, thus ensuring that a large number of structures are identical, or bear some fixed ratio to one another. However, it is difficult to ensure that the electrical characteristics among the several integrated circuits (10) are precisely the same. For example, a set of transistors among two or more integrated circuits may exhibit identical values of h_{FE}, but the actual numerical value of h_{FE} may be subject to wider tolerances. Thus, in effect, two integrated circuits fabricated next to one another may have slightly different electrical characteristics. Such a phenomena is known as process, or manufacturing, variations.

One particular variation that a chip designer has to compensate for involves those process variations that affect temperature measurements of an integrated circuit. It is becoming increasingly important to know the temperature parameters in which a particular integrated circuit operates because as circuit elements continue to get smaller and as more and more circuit elements are packed onto an integrated circuit, integrated circuits dissipate increased amounts of power, effectively causing integrated circuits to run hotter. Consequently, increased operating temperatures create a propensity for performance reliability degradation.

Because temperature considerations play a large part in the chip design process, it is imperative that a chip designer be able to make accurate temperature measurements of an integrated circuit. FIG. 2 shows a typical technique used to monitor temperatures involving the use of thermal sensors (20). Thermal sensors (20) are disposed on an integrated circuit, such as a microprocessor (22), in order to measure the temperatures at one or more points on the microprocessor (22). These temperature readings are then passed through a test processor unit (“TPU”) (24) on the microprocessor (22) to a service processor (26) that is external to the microprocessor (22). The TPU (24) both initiates the temperature sensors (20) to take measurements and functions as an interface from the microprocessor (22) to the outside world, e.g., system designers and system testing devices. The TPU (24), in effect, allows elements external to the microprocessor (22) to access measurements taken on the microprocessor (22) by the TPU (24). One such external element is the service processor (26). The service processor (26) coordinates the diagnostic activities of the computer system and monitors the overall health of a computer system, including the health of the microprocessor (22).

However, this technique is prone to inaccuracy because the thermal sensors (20) themselves are susceptible to process variations. Thus, temperature measurements taken by a thermal sensor (20) at one point on the integrated circuit may differ from the actual temperature at that point. One way a chip designer can balance for the effects of such process variations is to compensate for the entire cumulative range of temperatures among the several integrated circuits fabricated on a silicon wafer. However, the implementation of such gaurdbands is not optimal because chip designers must provide for increased temperature tolerances in the design of their integrated circuits. Thus, there is a need for an integrated circuit to be able to carry its own range, or ‘scale,’ of temperature calibration information so that a service processor or similar device can access the calibration information and determine an actual temperature based on the characteristics of an individual integrated circuit and not on the combined characteristics of the several integrated circuits fabricated on a particular silicon wafer.

### SUMMARY OF INVENTION

According to one aspect of the present invention, an integrated circuit comprises a thermal monitoring device and an electrical fuse register, where the electrical fuse register is used to store calibration information of the thermal monitoring device.

According to another aspect, a method for storing temperature calibration information on an integrated circuit comprises taking a calibration measurement of a thermal sensor and storing the calibration measurement into an electrical fuse register, where the electrical fuse register resides on the integrated circuit, and where taking the calibration measurement of the thermal sensor occurs at a known temperature.

According to another aspect, a method for determining an actual temperature at a location on an integrated circuit comprises taking a calibration measurement, at a known temperature, from a thermal monitoring device disposed at the location, storing the calibration measurement in an electrical fuse register disposed on the integrated circuit, and reading out the calibration measurement from the electrical fuse register, where the actual temperature at the location is determined based on the known temperature and the calibration measurement.

According to another aspect, a method for determining a temperature on an integrated circuit comprises a step for taking a calibration information of a thermal sensor residing on the integrated circuit, a step for storing the calibration information on the integrated circuit, and a step for reading out the calibration information when the temperature needs to be determined.

According to another aspect, an integrated circuit comprises means for storing calibration information on the integrated circuit and means for reading out the calibration information when a temperature on the integrated circuit needs to be determined.

Other aspects and advantages of the invention will be apparent from the following description and the appended claims.

### BRIEF DESCRIPTION OF DRAWINGS

FIG. 1 shows a typical silicon wafer used to fabricate integrated circuits.

FIG. 2 shows a typical technique used to measure a temperature on an integrated circuit.

FIGS. 3a, 3b, and 3c show a calibration reading/storing technique in accordance with an embodiment of the present invention.

FIG. 4 shows an electrical fuse register in accordance with an embodiment of the present invention.

FIG. 5 shows a flow process in accordance with an embodiment of the present invention.

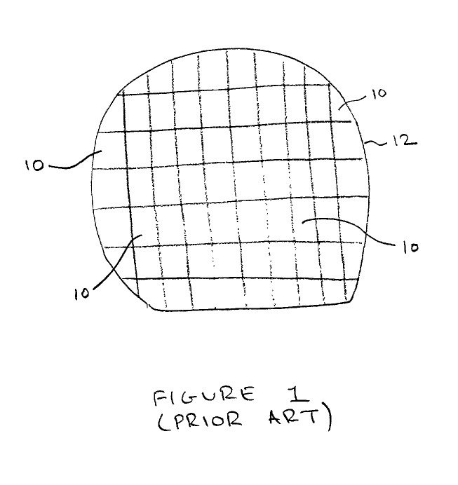

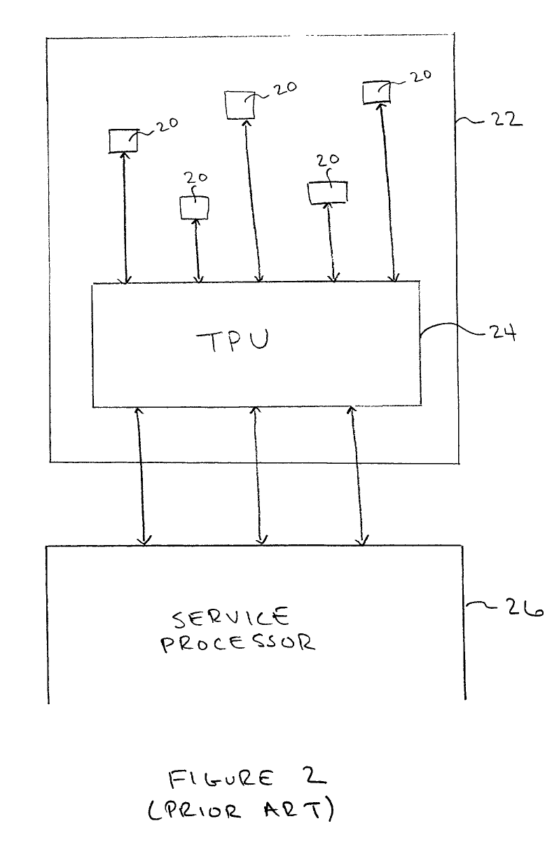

### DETAILED DESCRIPTION

Embodiments of the present invention relate to a technique for storing temperature calibrations on an integrated circuit through the use of electrical fuses. Embodiments of the present invention further relate to a technique for storing a temperature calibration on-chip so that a service processor or an equivalent thereof may query an integrated circuit for the temperature calibration in order to determine an actual temperature measurement.

The present invention uses electrical fuses to store a temperature monitoring device's calibration on an integrated circuit. By using such calibration data of a temperature monitoring device, such as a thermometer or thermal sensor, a chip designer can determine actual on-chip temperatures. This calibration may be formed using a high temperature and a low temperature. Using these temperature data points, a service processor or an equivalent thereof can determine, using linear interpolation, the actual temperature of the integrated circuit at the point on which the temperature monitoring device resides. The electrical fuse data, or calibration data, may be accessed by the service processor through the integrated circuit's test processor unit (“TPU”). Thus, the present invention proposes (1) taking a calibration measurement of an on-chip thermometers/thermal sensor disposed on an integrated circuit and (2) storing the calibration measurement into the integrated circuit using electrical fuses that can be accessed/read by an outside user/circuit.

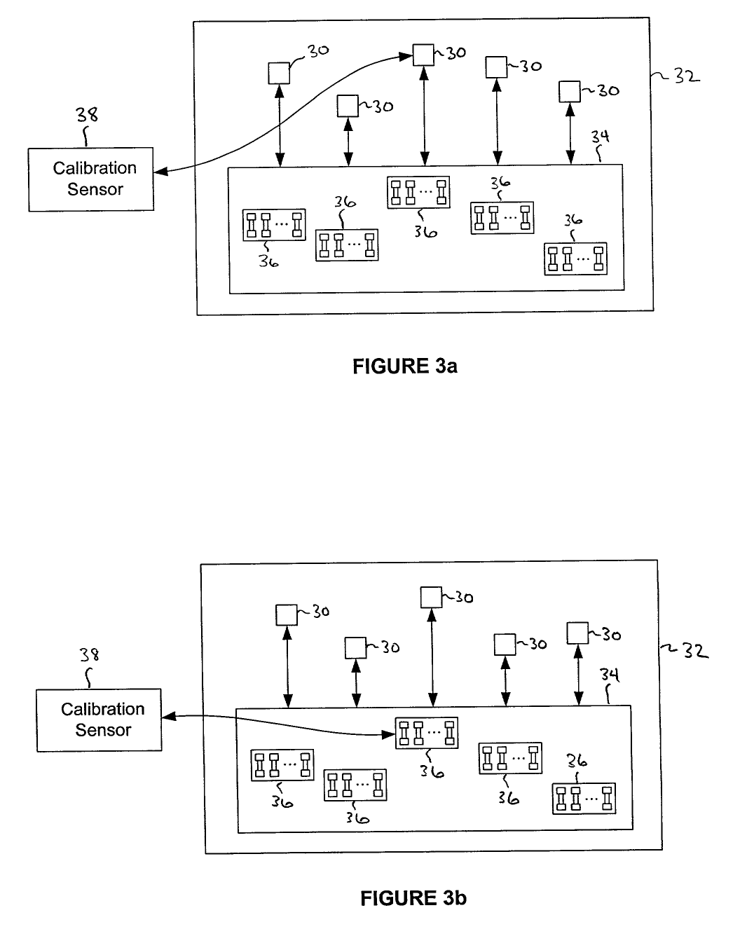

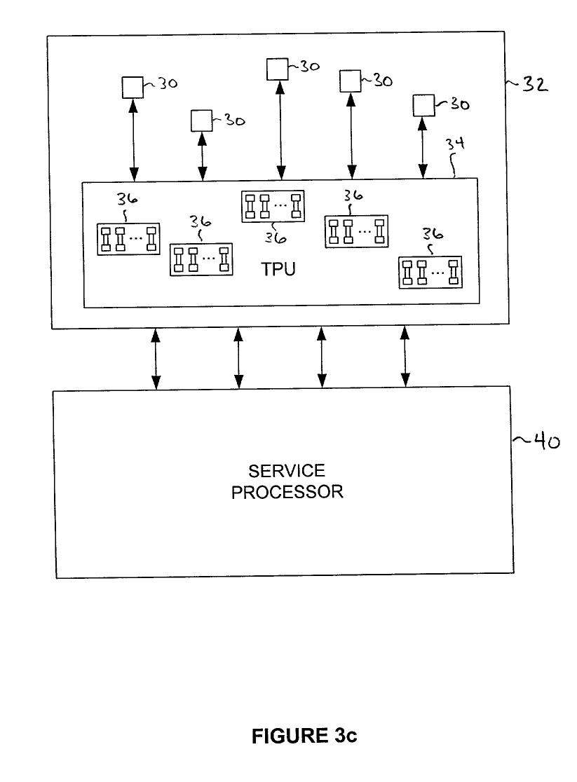

FIGS. 3a, 3b, and 3c depict the steps of an exemplary temperature calibration storage/reading technique in accordance with an embodiment of the present invention. Particularly, FIG. 3a shows several thermal sensors (30) on an integrated circuit (32), where the thermal sensors (30) are used to measure temperatures at one or more points on the integrated circuit (32). Moreover, the thermal sensors (30) are connected to a TPU (34) that both controls the operation of the thermal sensors (30) and serves as an interface to components external to the integrated circuit (32). The TPU (34) has, among other things, electrical fuse registers (36) that are used to store thermal sensor calibration data.

When a temperature calibration, i.e., a scale, for a particular thermal sensor (30) needs to be determined so that a temperature measurement taken by that particular thermal sensor can be actualized in consideration of the particular thermal sensor's unique electrical characteristics, a calibration sensor (38) is coupled to that particular thermal sensor (30) as shown in FIG. 3a. In this embodiment of the present invention, the integrated circuit (32) is put in a known temperature state, i.e., a state in which the temperature of the atmosphere around the integrated circuit is controlled, where after the calibration sensor (38) takes a calibration reading of the thermal sensor (30) to which it is connected.

Next, as shown in FIG. 3b, the calibration information stored in the calibration sensor (38) is read out to an electrical fuse register (36) that is associated with the thermal sensor (30) that the calibration sensor (38) took a calibration reading of. While the calibration information is read out to the electrical fuse register (38), the individual fuses within the electrical fuse register (38) are “burned-in” so as to represent a particular calibration value.

As shown in FIG. 3c, once a calibration value of a particular thermal sensor is burned into the appropriate electrical fuse register (38) and when a service processor (40) or equivalent thereof needs a temperature measurement from a particular thermal sensor (30), the TPU (34) provides the service processor (40) with the temperature reading of that particular thermal sensor (30) and the service processor (40) further accesses the calibration value from the electrical fuse register (38) associated with that particular thermal sensor (30). Using the temperature reading from the particular thermal sensor (30) and the calibration information of that particular thermal sensor (30), the service processor may determine an actual temperature at the point on the integrated circuit (32) where the particular temperature sensor (30) resides.

Those skilled in the art will appreciate that the calibration sensor (38) shown in FIGS. 3a and 3b may operate independent of the integrated circuit (32). Unlike a typical thermal sensor, the calibration sensor (38) has an off-chip interface (not shown) as opposed to an interface with the integrated circuit's TPU (34). Further, the calibration sensor (38) may have its own power supply. Such a calibration sensor (38) allows the integrated circuit (32) to be powered down during the process of determining the calibration information of a particular thermal sensor. This is important because the self-heating effects of the integrated circuit (32) may affect the accuracy of the calibration sensor's measurements, which, in turn, affect the accuracy of the actual temperature determinations made by the service processor (38).

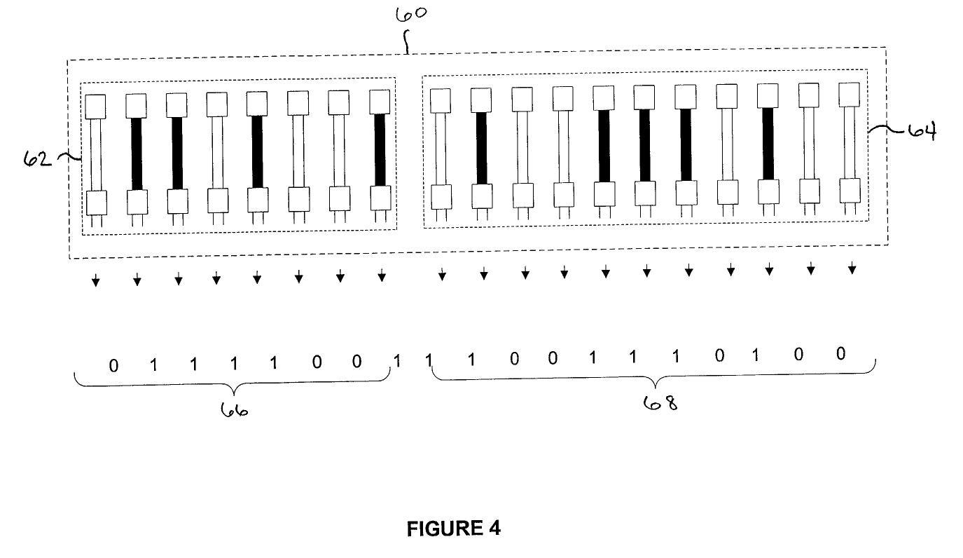

FIG. 4 shows an exemplary electrical fuse register (60) in accordance with an embodiment of the present invention. Particularly, FIG. 4 shows the fuse register (60) after a calibration value of a particular thermal monitoring device (not shown) has been stored, i.e., “burned in.” The fuse register (60), as shown in FIG. 4, has a plurality of fuses. The fuses may be grouped such that a first group of fuses (62) represents a known temperature value at which the calibration measurements for the particular thermal monitoring device were taken and such that a second group of fuses (64) represents the calibration measurement read in from the calibration sensor of the particular thermal monitoring device at the known temperature. Depending on whether a fuse is blown, in which case the fuse represents a ‘1,’ or still operational, in which case the fuse represents a ‘0,’ the first group (62) and second group (64) form digital words (66, 68) that can later be accessed by a service processor.

Those skilled in the art will appreciate that although the embodiment in FIG. 4 shows only two groups of fuses, other embodiments may use a different number of groups within the electrical fuse register. Further, a blown fuse may be used to represent a ‘0’ and a operational fuse may be used to represent a ‘1.’ Further still, although the embodiment shown in FIG. 4 depicts a particular number of electrical fuses, other embodiments may use a different number of electrical fuses depending on the level of precision desired. Moreover, an electrical fuse register as described in the present invention may be used to store calibration information for a high temperature reading and a low temperature reading.

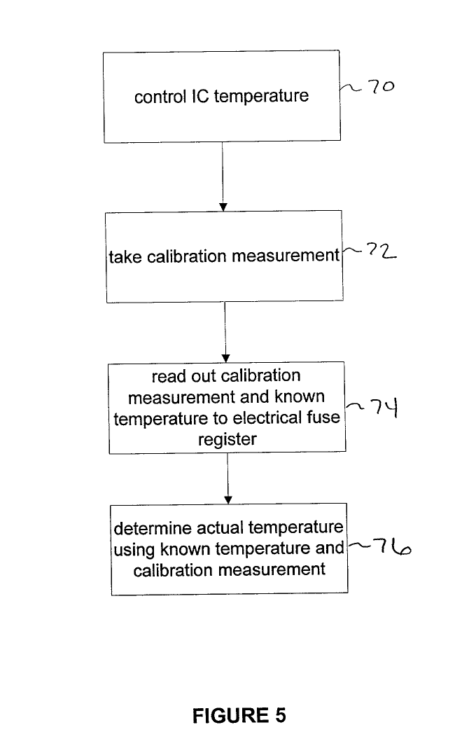

FIG. 5 shows an exemplary flow process in accordance with an embodiment of the present invention. Initially, temperature around an integrated circuit is controlled so as to allow one to know the temperature of the integrated circuit's surroundings (step 70). Once the temperature of the atmosphere surrounding the integrated circuit is known, a calibration sensor takes a temperature measurement from a particular thermal monitoring device on the integrated circuit (step 72). Thereafter, the calibration sensor reads out a calibration value for the particular thermal monitoring device to an electrical fuse register residing on the integrated circuit (step 74). Once the electrical fuse register is burned in with the calibration value of the particular thermal monitoring device, the integrated circuit can be implemented into a computer system which can thereafter determine an actual temperature on the integrated circuit using a temperature measurement from the particular thermal sensor and the on-chip calibration value of that particular thermal monitoring device (step 76).

Advantages of the present invention may include one or more of the following. In some embodiments, because an integrated circuit stores calibration information for its thermal monitoring device on-chip, a service processor or equivalent thereof may directly or indirectly query the calibration information to determine an actual temperature of the integrated circuit at the point on which the thermal monitoring device resides.

In some embodiments, because an integrated circuit carries its own calibration information, such integrated circuits may be swapped out without affecting the function of a computer system in which the integrated circuits reside.

In some embodiments, because calibration information corresponding to a particular integrated circuit's thermal sensor is stored on-chip, the effects of process and manufacturing variations may be minimized when taking a temperature measurement using the thermal sensor.

In some embodiments, because a calibration measurement taken by a calibration sensor is stored in a test processing unit of a microprocessor, external testing devices may have access to the calibration measurement when the microprocessor is in use.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An integrated circuit, comprising:
a thermal monitoring device; and
an electrical fuse register,
wherein the electrical fuse register is used to store calibration information of the thermal monitoring device.

2. The integrated circuit of claim 1, wherein the thermal monitoring device is a thermal sensor disposed on the integrated circuit.

3. The integrated circuit of claim 1, further comprising:
a test processor unit comprising the electrical fuse register, and wherein the test processor unit controls the thermal monitoring device.

4. The integrated circuit of claim 1, wherein the test processor unit is accessible by a service processor.

5. The integrated circuit of claim 1, wherein the electrical fuse register comprises:
a first plurality of electrical fuses that are used to represent a calibration value of the thermal monitoring device; and
a second plurality of electrical fuses that are used to represent a temperature at which the calibration value of the thermal monitoring device was attained.

6. The integrated circuit of claim 5, wherein the value of the first and second pluralities of electrical fuses are digital words that can be read out from a test processor unit residing on the integrated circuit.

7. A method for storing temperature calibration information of a thermal sensor on an integrated circuit, comprising:
taking a calibration measurement of the thermal sensor; and
storing the calibration measurement into an electrical fuse register, wherein the electrical fuse register resides on the integrated circuit,
wherein taking the calibration measurement of the thermal sensor occurs at a known temperature.

8. The method of claim 7, further comprising:
storing a value of the known temperature into the electrical fuse register.

9. The method of claim 7, wherein the thermal sensor is disposed on the integrated circuit.

10. The method of claim 7, wherein the electrical fuse register is associated with the thermal sensor.

11. The method of claim 7, wherein a calibration sensor takes the calibration measurement of the thermal sensor, and wherein the calibration sensor operates independent of the integrated circuit.

12. A method for determining an actual temperature at a location on an integrated circuit, comprising:
taking a calibration measurement, at a known temperature, from a thermal monitoring device disposed at the location;
storing the calibration measurement in an electrical fuse register disposed on the integrated circuit; and
reading out the calibration measurement from the electrical fuse register,
wherein the actual temperature at the location is determined based on the known temperature and the calibration measurement.

13. The method of claim 12, further comprising:
storing a value of the known temperature in the electrical fuse register.

14. The method of claim 12, wherein the thermal monitoring device is a thermal sensor.

15. The method of claim 12, wherein a calibration sensor, operating independent of the integrated circuit, takes the calibration measurement from the thermal monitoring device and stores the calibration measurement in the electrical fuse register.

16. The method of claim 12, wherein fuses within the electrical fuse register represent binary values that can be read out to a service processor, wherein the service processor determines the actual temperature dependent on the binary values.

17. A method for determining a temperature on an integrated circuit, comprising:
a step for taking a calibration information of a thermal sensor residing on the integrated circuit;
a step for storing the calibration information on the integrated circuit; and
a step for reading out the calibration information when the temperature needs to be determined.

18. An integrated circuit, comprising:
means for storing calibration information on the integrated circuit; and
means for reading out the calibration information when a temperature on the integrated circuit needs to be determined.
